(19) United States
(12) Patent Application Publication
(10) Pub. No.: US 2003/0021586 A1
(43) Pub. Date: Jan. 30, 2003

(54) Combination system having optical recording/reproducing apparatus and television, and method of controlling of displaying caption and subtitle

(75) Inventor: Jung-Soo Suh, Suwon-city (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/195,714

(22) Filed: Jul. 16, 2002

(30) Foreign Application Priority Data
Jul. 24, 2001 (KR) 2001-44355
Apr. 3, 2002 (KR) 2002-18311

(51) Int. Cl. H04N 5/781

(52) U.S. Cl. 386/95; 386/125

(57) ABSTRACT

A combination system of optical or other recording/reproducing apparatus and a television has a subtitle unit disposed in the optical recording/reproducing apparatus; a caption unit disposed in the television; and a controlling unit. The controlling unit stops the operation of the caption unit when a mode to operate the optical recording/reproducing apparatus is set up. In addition, the controlling unit operates the caption unit and displays the subtitle data and the caption data at different positions on a screen of the television when a mode to simultaneously operate the subtitle unit and the caption unit is set up. Therefore, the subtitle data and the caption data are not overlapped on the screen.

### BACKGROUND OF THE INVENTION

1. Field of the Invention

The present invention relates to a recording/reproducing apparatus and a television, and more particularly, to a combination system having a recording/reproducing apparatus and a television. The present application is based on Korean Patent Application No. 2001-44355, filed Jul. 24, 2001, and on Korean Patent Application No. 2002-18311, filed Apr. 3, 2002, both of which are incorporated in full herein by reference.

2. Description of the Prior Art

Generally in a ‘combination system’ or a ‘combo-system’ more than two different apparatuses are integrated as one system, and it is also called a ‘combo’. As one example of a combo-system, a combination system to effectively perform the functions of a television and a DVDP (digital versatile disk player) has been developed.

A television is an apparatus to receive a broadcasting signal transmitted from a station and broadcast the broadcasting signal. On the other hand, a DVDP is an apparatus to reproduce the data recorded on a DVD (digital versatile disk). Data reproduced by the DVDP is video data, audio data, subtitle data. The subtitle data is general text data for being displayed on the screen corresponding to the audio data.

Recently, the broadcasting station performs caption broadcasting that transmits text data (hereinbelow, it will be referred to ‘caption data’) included in VBI (vertical blanking interval) of the broadcasting signal in order to improved the watching efficiency and for the benefit of the people who have hearing problems. Therefore, a television having a separate decoder (hereinbelow, it will be referred to ‘caption unit’) to decode the caption data transmitted by being included in the composite video blanking synchronization (CVBS) has been generalized.

Moreover, not only the caption broadcasting for the people who have hearing problems but also the caption data is included in the video data recoded in VCR and DVD is standardized in the USA. The caption data included in the video data can be the same with the subtitle data, or it can be sentences describing the situation that cannot be informed using the subtitle. The text data recoded in the DVD has subtitle data and caption data included in the video data. Yet, a decoder (hereinbelow, it will be referred to ‘subtitle unit’) is generally disposed in the DVDP in order to decode only subtitle data.

Therefore, the caption data included in the composite video blanking synchronization (CVBS) and the video data is decoded by the television having the caption function, and the subtitle data recorded in the DVD is decoded at the subtitle unit in the DVDP.

Accordingly, in the combination system of DVDP/TV having the DVDP and the television in one system, the caption data included in the composite video blanking synchronization (CVBS) of the DVD can be decoded by a caption unit of the television. While the caption unit of the television is being operated, when the data recorded on the DVD is reproduced as the DVDP is operated, and the subtitle unit of the DVDP and the caption unit of the television are simultaneously operated. Therefore, the subtitle data and the caption data is respectively decoded. Accordingly, there is a problem that the subtitle data and the caption data decoded on the screen of the television is overlapped.

### SUMMARY OF THE INVENTION

The present invention has been made to overcome the above-mentioned problem of the prior art. Accordingly, it is the object of the present invention to provide a combination system having a recording/reproducing apparatus and a television that displays caption data and subtitle data by avoiding overlapping on a screen of the television when reproducing the data recorded on an optical or other recording medium.

The above object of the present invention is realized by providing a combination system comprising: a subtitle unit disposed in the optical recording/reproducing apparatus, and the subtitle unit to decode a subtitle data included in the reproduced data; a caption unit disposed in the television, and the caption unit to decode a caption data included in the data transmitted from the optical recording/reproducing apparatus; and a controlling unit to control an operation of the subtitle unit and the caption unit to selectively operate the subtitle unit and the caption unit.

The controlling unit includes a first microprocessor to control the operation of the subtitle unit and a second microprocessor to control the operation of the caption unit.

It is preferable that when a mode to operate the optical recording/reproducing apparatus is set up, the second microprocessor stops the operation of the caption unit. Moreover, the second microprocessor operates the caption unit and displays the subtitle data and the caption data at different positions on a screen of the television when a mode to operate the subtitle unit and the caption unit simultaneously is set up.

In the meantime, a method for controlling a subtitle displaying of a combination system having an optical recording/reproducing apparatus, comprising the steps of: operating the subtitle unit and stopping an operation of the caption unit when a mode to operate the optical recording/reproducing apparatus is set up; and displaying the subtitle data decoded by the subtitle unit on a screen of the television.

Furthermore, the method includes the steps of: decoding the subtitle data and the caption data by the subtitle unit and the caption unit when a mode to simultaneously operate the subtitle unit and the caption unit; and displaying the decoded subtitle data and the caption data at different positions on a screen of the television.

### BRIEF DESCRIPTION OF THE DRAWINGS

The above-mentioned object and the feature of the present invention will be more apparent by describing the preferred embodiment of the present invention by referring to the appended drawings, in which:

FIG. 1 is a block diagram showing a combination system of an optical recording/reproducing apparatus and a television according to the present invention;

FIG. 2 is a flow chart showing a method for controlling the operation of a subtitle unit and a caption unit of FIG. 1; and

FIG. 3 is a flow chart showing another method for controlling the operation of a subtitle unit and a caption unit of FIG. 1.

### DESCRIPTION OF THE PREFERRED EMBODIMENTS

Hereinbelow, the present invention will be described in greater detail by referring to appended drawings. In the preferred embodiment of the present invention, a combination system having a DVDP as an optical recording/reproducing apparatus will be described. Moreover, caption data described here is text data included in CVBS of a broadcasting signal and data reproduced at a DVDP, and the subtitle data is text data that is one of the data reproduced at the DVDP.

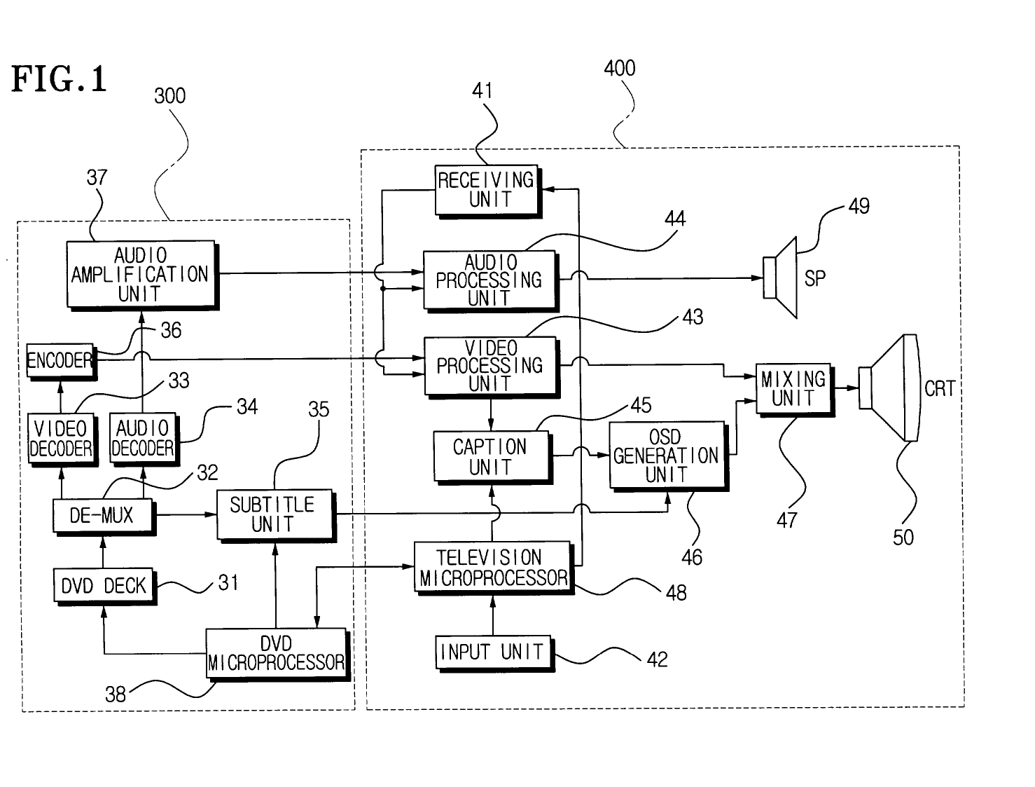

FIG. 1 is a block diagram showing a combination system of the DVDP 300 and a television 400 according to the preferred embodiment.

The DVDP 300 has a DVD deck 31, a DE-MUX 32, a video decoder 33, an audio decoder 34, a subtitle unit 35, an encoder 36, an audio amplification unit 37, and a DVD microprocessor 38. The optical recording/reproduction apparatus may be implemented as a DVD or a video player, and may include data compression capabilities such as those compatible with MPEG standards. It may also be any device or article of manufacture capable of transmitting a video image. The term “DVD” as used herein may include any of the foregoing devices.

The DVD deck 31 reads the data recorded on a DVD.

The DE-MUX 32 outputs dada read at the DVD deck 31 in accordance with the control of the DVD microprocessor 38 after separating the data into video data, audio data, and subtitle data.

The video decoder 33 outputs digital video data output from the DE-MUX 32 after restoring the digital video data. The audio decoder 34 outputs digital audio data output from the DE-MUX 32 after restoring the digital audio data.

The subtitle unit 35 decodes subtitle data output from the DE-MUX 32.

The encoder 36 converts video data output from the video decoder 33 into a composite video blanking synchronization (CVBS) after encoding the video data into a single video signal. The composite video blanking synchronization (CVBS) includes the caption data.

The audio amplification unit 37 amplifies audio data output from the audio decoder 34 and outputs the audio data to outside through a speaker 49 installed at the television 400.

The DVD microprocessor 38 controls the operation of the entire DVDP 300 as described before, and transmits a controlling command with a television microprocessor 48 described later.

The television 400 has a receiving unit 41, an input unit 42, a video processing unit 43, an audio processing unit 44, a caption unit 45, an OSD generation unit 46, a mixing unit 47, a television microprocessor 48, a speaker 49, and a CRT 50.

The input unit 42 can be a manipulation panel (not shown) having a plurality of buttons on a television body and a remote controller (not shown) can be controlled from a remote place. A user inputs a selection command for the operation of the DVDP and the television into the input unit 42. For example, the selection command is for mode conversion. Mode is a selection mode for DVD mode to operate the DVDP, television mode to operate the television, and operation mode for the subtitle unit 35 and the caption unit 45. The DVD mode can be selected when a DVD is inside the DVD deck 31, and the television mode can be selected when power to the combination system is on.

The audio processing unit 44 processes the audio signal among the broadcasting signals transmitted from the receiving unit 41, and from the audio amplification unit 37, and the processed audio signal is output to the outside through the speaker 49.

The video processing unit 43 processes the composite video blanking synchronization (CVBS) among the broadcasting signals transmitted from the receiving unit 41 and the composite video blanking synchronization (CVBS) output from the encoder 36 in the DVDP 300, and outputs the processed video signal to the outside through the CRT 50.

The caption unit 45 decodes caption data included in the composite video blanking synchronization (CVBS), which is a caption broadcasting signal in accordance with the control of the television microprocessor 48.

The OSD generation unit 46 generates the caption data and the subtitle data decoded from the caption unit 45 and the subtitle unit 35 as an OSD screen.

The mixing unit 47 mixes caption and subtitle generated from the OSD generation unit 46 and the composite video blanking synchronization (CVBS) processed at the video processing unit 43.

The television microprocessor 48 controls the operation of the entire television, and transmits the controlling command with the DVD microprocessor 38.

When the user selects the mode set up for the simultaneous operation of the subtitle unit 35 and the caption unit 45, the television microprocessor 48 controls the subtitle data and the caption data so that they do not overlap when displayed on the CRT 50. For example, the television microprocessor 48 controls the subtitle unit 35 and the caption unit 45 in order to display the caption data decoded at the caption unit 45 and the subtitle data decode at the subtitle unit 35 at different places at the CRT 50. Further, the term “television screen” as herein used may include various types of displays coupled to the combined system, including a CRT monitor, a flat screen or other type of screen or video display. The “television screen” may also be implemented as a projection device which projects to a user, or some other type of display device capable of conveying video information to a user. The “television” may be physically integrated with or connected to the television screen, or the television may be otherwise coupled to the television screen in a manner sufficient to transmit data containing video information. The DVD or optical recording/reproducing apparatus may be physically integrated with, or connected to the television. As is known to those skilled in the art, alternatively, the DVD or optical recording/reproducing apparatus may be coupled in some other manner sufficient to carry out the tasks herein described.

Hereinbelow, the method for controlling the displaying operation of the subtitle and the caption in the DVDP/TV combination system according to the present invention will be described referring to the appended drawings.

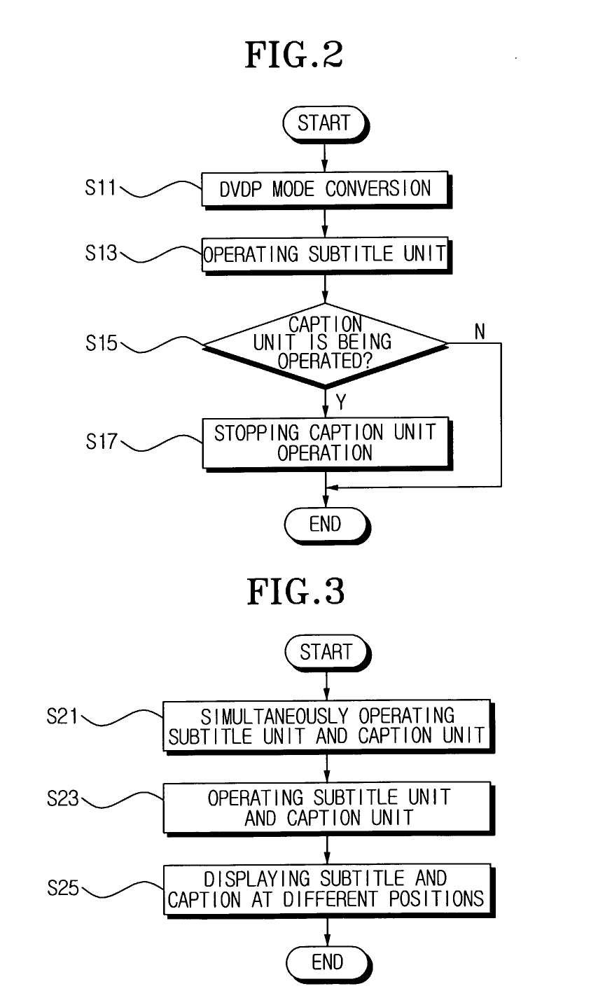

FIG. 2 is a flow chart showing one preferred embodiment of the method for controlling the displaying operation of the subtitle and caption according to the present invention.

When the mode is converted into a mode for operating the DVDP 300 (S 11), the television microprocessor 48 receives the command and transmits the command to the DVD microprocessor 38. The DVD microprocessor 38 allows the DVD deck 31 to start to reproduce the data recorded on the DVD after reading the data as the command for reproducing DVD is transmitted. The DVD mode conversion can be done either manually or automatically. For example, when the mode is converted manually, the user inputs the command for mode conversion through the input unit 42 such as the manipulation panel or the remote controller, and when the mode is converted automatically, a DVD is settled on the DVD deck 31.

The DVD microprocessor 38 operates the subtitle unit 35 (S 13). The subtitle unit 35 decodes the subtitle data separated at the DE-MUX 32, and the subtitle unit 35 inputs the subtitle data decoded to the OSD generation unit 46 in the television 400.

At this time, the television microprocessor 48 detects the operation of the caption unit 45, and when the caption unit 45 is being operated (S 15), then stops the operation of the caption unit 45 so as not to allow the caption data included the composite video blanking synchronization (CVBS) transmitted from the DVDP 300 to be decoded (S 17).

The data read at the DVD deck 31 is output after being separated as video, audio and subtitle data by the DE-MUX 32. The video data is restored to an original digital video signal at the video decoder 33, and the restored video signal is encoded into the composite video blanking synchronization (CVBS) by the encoder 36. The output composite video blanking synchronization (CVBS) is input into the video processing unit 43 of the television 400.

Therefore, the subtitle data decoded at the subtitle unit 35 and the composite video blanking synchronization (CVBS) processed at the video processing unit 43 are mixed at the mixing unit 47 and then are displayed to the output through the CRT 50.

In addition, the audio data of the DVD is output as a predetermined audio signal by the audio decoder 34 and the audio amplification unit 37, then the audio data is processed at the audio processing unit 44 in the television 400 and lastly is output to the outside through the speaker 49.

FIG. 2 shows one example of operating the subtitle unit 35 automatically and stopping the caption unit 45 when the DVD mode is selected. However, the user can select the operation of the subtitle unit 35 and the caption unit 45 through the input unit 42 such as through the manipulation panel or the remote controller. The terms user selection, input and command as herein used can include commands entered by activating buttons, including “soft” buttons, knobs or sensors, including touch, biometric, and optical sensors on the combination system, on the television, or on the optical recording/reproduction apparatus, or on a remote control device coupled to one or more of these. It also includes commands entered via a computer or other external device coupled to a combination system, the television or the optical recording/reproduction apparatus, and may also include a voice command directed to any of the foregoing devices, and a combination of voice and other commands.

For example, when the mode is set up to operate the DVDP 300, the DVD microprocessor 38 operates the subtitle unit 35 in order to decode the subtitle data and display the subtitle data with the video signal on the CRT 50 as shown in FIG. 2.

At this time, when the user converts to the mode for operating the caption unit 45, the television microprocessor 38 transmits a command for stopping the operation of the subtitle unit 35 to the DVD microprocessor 38 and stops the operation of the subtitle unit 35, and the television microprocessor 48 operates the caption unit 45. Accordingly, the caption unit 45 in the television 400 decodes the caption data included in the composite video blanking synchronization (CVBS) encoded at the encoder 36 in the DVDP 300 and after that the caption data is displayed with the video signal on the CRT 50.

So far, the general method for controlling the operation of the subtitle unit 35 and the caption unit 45 when the DVDP 300 of the DVDP/TV combination system is operated.

Hereinbelow, the case that the user selects the mode for displaying the subtitle data and the caption data after decoding the subtitle data and the caption data simultaneously when the DVDP 300 is played will be described.

FIG. 3 is flow chart showing a method for controlling the operation when a mode set up to display the subtitle data and the caption data simultaneously on the CRT 50.

When the user selects the mode for simultaneously operating the subtitle unit 35 and the caption unit 45 of the DVD through the input unit 42 (S 21), the television microprocessor 48 transmits the command for selecting the mode to the DVD microprocessor 38. The DVD microprocessor 38 operates the subtitle unit 35 corresponding to the selection command. As the subtitle unit 35 is operated, the subtitle data input from the DE-MUX 32 is decoded (S 23), and the decoded subtitle data is input into the OSD generation unit 46 in the television 400.

In the meantime, the television microprocessor 48 operates the caption unit 45 in order to decode the caption data included in the composite video blanking synchronization (CVBS) encoded at the encoder 36 in the DVDP 300 (S 23). At this time, the television microprocessor 48 controls the caption unit 45 to change the display position of the caption data in order not to display the caption data at the same place with the subtitle data decoded at the subtitle unit 38 on the CRT 50 (S 25).

Therefore, even when the subtitle data and the caption data are displayed simultaneously on the same screen, the position for each data is different and not overlapped.

The processing of the video signal and the audio signal at each block follows the same process described before, thus it will be omitted here.

As described so far, as the operation of the subtitle unit 35 in the DVDP 300 and the caption unit 45 in the television 400 is selectively controlled when the mode is to operate the DVDP 300, overlapping of the subtitle data and the caption data on the CRT 50 can be prevented.

Furthermore, when the subtitle data and the caption data are displayed on the CRT 50, the subtitle unit 35 and the caption unit 45 are controlled not to overlap respective data.

According to the present invention, in the case DVDP 300 is operated in the DVDP/TV combination system, generally the subtitle unit 35 is operated and the caption unit 45 in the television 400 is not operated, thus the subtitle data and the caption data is not overlapped on the CRT 50.

Moreover, when the user selects to display the subtitle data and the caption data simultaneously on the CRT 50, the subtitle unit 35 and the caption unit 45 are controlled to display the subtitle data and the caption data from being displayed at different places on the CRT 50.

Although the preferred embodiments of the present invention have been described, it will be understood by those skilled in the art that the present invention is not limited to the described preferred embodiments, but various changes and modifications can be made within the spirit and the scope of the present invention. Accordingly, the scope of the present invention is not limited within the described range but by the following claims.

What is claimed is:

1. A combination system having a recording/reproducing apparatus configured to reproduce data recorded on a recording medium and a television configured to output the data reproduced at the recording/reproducing apparatus, the combination system comprising:
a subtitle unit disposed in the recording/reproducing apparatus, the subtitle unit configured to decode a subtitle data included in the reproduced data;
a caption unit disposed in the television, the caption unit configured to decode a caption data included in the data transmitted from the recording/reproducing apparatus; and
a controlling unit configured to control an operation of the subtitle unit and the caption unit to operate selectively the subtitle unit and the caption unit.

2. The combination system of claim 1, wherein the controlling unit includes a first microprocessor configured to control the operation of the subtitle unit and a second microprocessor configured to control the operation of the caption unit and, when a mode to operate the recording/reproducing apparatus is set, to stop the operation of the caption unit.

3. The combination system of claim 1, wherein the controlling unit includes a first microprocessor configured to control the operation of the subtitle unit and a second microprocessor configured to control the operation of the caption unit, and the second microprocessor operates the caption unit when a mode is selected to operate simultaneously the subtitle unit and the caption unit.

4. The combination system of claim 3, wherein the second microprocessor is further configured to display the subtitle data and the caption data at different positions on a screen of the television.

5. The combination system of claim 4, wherein the second microprocessor is further configured to change a displaying position of the caption data.

6. A method of controlling subtitle display in a combination system having a recording/reproducing apparatus and a television configured to output data reproduced at the recording/reproducing apparatus, a subtitle unit disposed in the recording/reproducing apparatus and a caption unit disposed in the television, the caption unit configured to process caption data included in the reproduced data, the method comprising:
decoding the subtitle data by operating the subtitle unit; and
stopping an operation of the caption unit when a mode to operate the recording/reproducing apparatus is set; and
displaying the decoded subtitle data on a screen of the television.

7. A combination system including a recording/reproducing apparatus configured to reproduce data recorded on a recording medium and a television configured to output data reproduced at the recording/reproducing apparatus, comprising:
a subtitle unit disposed in the recording/reproducing apparatus, the subtitle unit configured to decode a subtitle data included in the reproduced data;
a caption unit disposed in the television, the caption unit configured to decode a caption data included in the reproduced data; and
a controlling unit configured to control an operation of the subtitle unit and the caption unit, and
wherein the controlling unit controls the subtitle unit and the caption unit to display the subtitle data and the caption data at different places on a screen of the television when a mode to simultaneously operate the subtitle unit and the caption unit is set.

8. The combination system of claim 7, wherein the controlling unit includes a first microprocessor configured to control an operation of the subtitle unit and a second microprocessor configured to control an operation of the caption unit and to change a display position of the caption data decoded by the caption unit.

9. A method of controlling subtitle displaying of a combination system having a recording/reproducing apparatus configured to reproduce a data recorded on a recording medium, a television configured to output the data reproduced at the recording/reproducing apparatus, and a subtitle unit disposed in the recording/reproducing apparatus and a caption unit disposed in the television to process, respectively, a subtitle data and a caption data included in the data, the method comprising:
decoding the subtitle data by the subtitle unit and the caption data by the caption unit when a mode to operate simultaneously the subtitle unit and the caption unit is set; and
displaying the decoded subtitle data and the caption data at different positions on a screen of the television.
